(19) United States
(12) Patent Application Publication
(10) Pub. No.: US 2013/0104033 A1
(43) Pub. Date: Apr. 25, 2013

(54) DESCRIPTION METHOD, EXI DECODER AND COMPUTER READABLE MEDIUM

(71) Applicant: KABUSHIKI KAISHA TOSHIBA, Tokyo (JP)

(72) Inventors: Yusuke Doi, Kanagawa-ken (JP); Yumiko Sakai, Kanagawa-ken (JP)

(73) Assignee: KABUSHIKI KAISHA TOSHIBA, Tokyo (JP)

(21) Appl. No.: 13/654,498

(22) Filed: Oct. 18, 2012

(30) Foreign Application Priority Data
Oct. 21, 2011 (JP) 2011-232007

(51) Int. Cl. G06F 17/00

(52) U.S. Cl. 715/234

(57) ABSTRACT

A description method of an extension schema and an XML (Extensible Markup Language) document corresponding to the extension schema, for encoding or decoding compatible with both a basic schema and the extension schema based on an EXI (Efficient XML Interchange), the basic schema defining at least one data type, wherein the extension schema includes description to import the basic schema and description to define an extended data type which is a data type derived from one of the at least one data type and the XML document corresponding to the extension schema includes description to designate the extended data type with use of an attribute for type extension defined by an XML schema instance specification.

### CROSS REFERENCE TO RELATED APPLICATIONS

This application is based upon and claims the benefit of priority from the prior Japanese Patent Application No. 2011-232007, filed on Oct. 21, 2011, the entire contents of which are incorporated herein by reference.

### FIELD

An embodiment relates to a description method, an EXI (Efficient XML (Extensible Markup Language) Interchange) decoder and a computer readable medium.

### BACKGROUND

EXI is a technique of creating compact binary expression of XML using grammatical knowledge (schema) of XML and is defined by Non-Patent Document 1 (John Schneider and Takuki Kamiya. Efficient XML Interchange (EXI) Format 1.0. W3C Recommendation, March 2011. http://www.w3.org/TR/exi/). In the prior art, there is known a data compression scheme using EXI.

In modes of EXI, a schema-informed grammar generates a state machine indicating state transitions that can be taken by each part in a text, from the schema, and encodes the text using this state machine.

For the purpose of information exchange by EXI, extension schema may be defined in which, with respect to a standard or fundamental schema (i.e. basic schema), a data type is extended by individual vendors. Due to individual definition of the extension schema, state machines (i.e. type grammars) with respect to individual vendor's extension schemes are required and therefore a storage area size such as a ROM size required for implementation increases.

This is a unique problem due to change of a code bit width caused by variation in the number of states of the state machine used for encoding and decoding in EXI.

### BRIEF DESCRIPTION OF THE DRAWINGS

FIG. 1 is a diagram illustrating a configuration of an EXI decoder compatible with a plurality of schemas according to an embodiment;

FIG. 2 is a diagram illustrating a configuration example of an EXI stream;

FIG. 3 is an image diagram illustrating a memory storage scheme of an EXI grammar in the related art;

FIG. 4 is an image diagram of a memory storage scheme of an EXI grammar according to the present embodiment;

FIG. 5 is a diagram illustrating a configuration example of a grammar store;

FIG. 6 is a diagram illustrating a configuration example of the basic schema;

FIG. 7 is a diagram illustrating an example of an XML document based on the basic schema;

FIG. 8 is a diagram illustrating an example of an extension schema according to a conventional scheme;

FIG. 9 is a diagram illustrating an example of an XML document based on an extension schema according to a conventional scheme;

FIG. 10 is a diagram illustrating an example of an extension schema according to the present embodiment;

FIG. 11 is a diagram illustrating an example of an XML document based on an extension schema according to the present embodiment;

FIG. 12 is a state transition diagram based on orderType defined in the basic schema;

FIG. 13 is a state transition diagram based on plateType defined in the basic schema;

FIG. 14 is a state transition diagram based on orderType defined in the extension schema according to the conventional scheme;

FIG. 15 is a state transition diagram based on plateType defined in the extension schema according to the conventional scheme;

FIG. 16 is a state transition diagram based on patternedPlateType defined in the extension schema according to the conventional scheme;

FIG. 17 is a state transition diagram based on orderType defined in the extension schema according to the present embodiment;

FIG. 18 is a state transition diagram based on plateType defined in the extension schema according to the present embodiment; and

FIG. 19 is a state transition diagram based on patternedPlateType defined in the extension schema according to the present embodiment.

### DETAILED DESCRIPTION

According to an embodiment, there is provided a description method of an extension schema and an XML (Extensible Markup Language) document corresponding to the extension schema, for encoding or decoding compatible with both a basic schema and the extension schema based on an EXI (Efficient XML Interchange), the basic schema defining at least one data type.

The extension schema is described such that the extension schema includes description to import the basic schema and description to define an extended data type which is a data type derived from one of the at least one data type.

The XML document corresponding to the extension schema is described such that the XML document includes description to designate the extended data type with use of an attribute for type extension defined by an XML schema instance specification.

According to an embodiment, there is provided an EXI decoder which decodes an EXI (Efficient XML (Extensible Markup Language) Interchange)) stream, including: a grammar store, a stream input unit and a parser unit.

The grammar store stores a first type grammar(s) and a second type grammar(s).

The first type grammar is a type grammar generated according to an EXI specification from a basic schema of an XML. The basic schema defines at least one data type and the first type grammar is generated correspondingly to each of the at least one data type.

The second type grammar is a type grammar that, among type grammars generated according to the EXI specification from an extension schema of XML, a type grammar common to the first type grammar is excluded. The extension schema defines at least one data type and each of the type grammars is generated correspondingly to each of the at least one data type. The extension schema includes description to import the basic schema and description to define an extended data type which is a data type derived from one of the at least one data type.

The stream input unit receives an EXI stream.

The parser unit decodes the EXI stream, when the EXI stream is compatible with the basic schema, based on the first type grammar, and, when the EXI stream is compatible with the extension schema, based on the first type grammar and the second type grammar.

Hereinafter, embodiments will be described with the accompanying drawings.

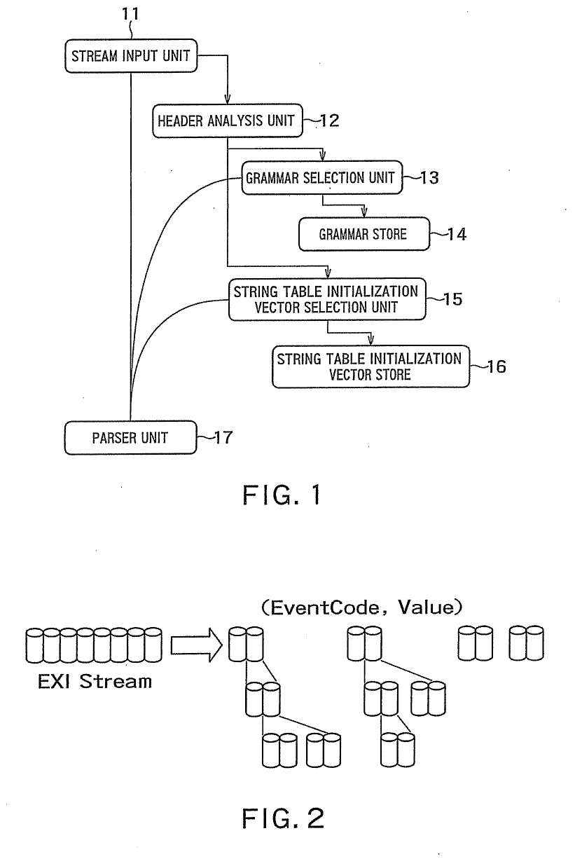

FIG. 1 illustrates a configuration of an EXI decoder compatible with a plurality of schemes according to an embodiment. A stream input unit 11 receives an EXI stream. The input stream is an arbitrary byte sequence read from a network such as TCP/IP and UDP/IP or a file system. The stream Input unit 11 outputs a header and header option included in the EXI stream to a header analysis unit 12 and a stream body to a parser unit 17.

The header analysis unit 12 analyzes the header and the header option of the EXI stream and extracts the option of the EXI stream. The option includes a schema Id (schemaId). This schemaId is output to a grammar selection unit 13 and a string table initialization vector selection unit 15.

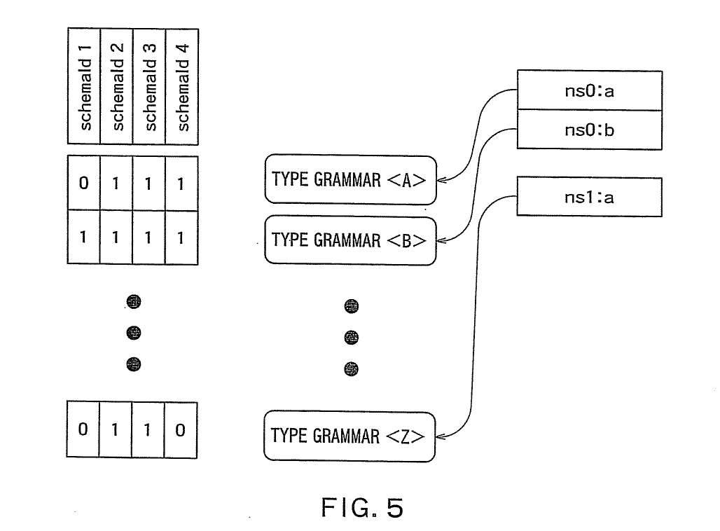

The grammar store 14 holds all EXI grammars corresponding to all schemas that can be used in the parser unit 17, and grammar set table wherein the grammar set table is information as to which schemaId the individual grammars are used in. The information Is formed as a bitmap, etc. Also, regarding some grammars, the grammar store 14 holds a table indicating a correspondence relationship between QName (Qualified Name) indicating a type (or Type) and a grammar. The grammar includes, for example, a grammar called from “xsi:type”. The xsi:type is a specification defined by XML-Schema-Instance specification. The xsi:type explicitly specifies a type at which XML element is interpreted. The detail of xsi:type will be described later. A configuration of the grammar store 14 is illustrated in FIG. 5.

In FIG. 5, “1” shows that the corresponding grammar is used, and “0” shows that the corresponding grammar is not used. For example, in the case of schemaId 4, grammars A and B are used but grammar Z is not used. It should be noted that grammars A, B, Z represent grammar names abstractly. Also, ns0:a, ns0:b and ns1:a represent QName abstractly. Here, ns0 and ns1 correspond to a name space, and a and b correspond to a local name.

To be more specific, each type grammar is a state machine (grammar) corresponding to each type. An available grammar(s) is shown for individual schemaId in the form of a bitmap with the schemaId used as a key. Also, in the table on the right side of the figure, a type grammar is looked up using QName (which is a pair of a name space and a name) as a key.

With reference to the schemaId reported from the header analysis unit 12, the grammar selection unit 13 selects a set of grammars to be used and a corresponding part of the grammar set table (i.e. a part of grammar set table corresponding to the schemaId) from the grammar store 14 and sends them to the parser unit 17.

A string table initialization vector store 16 holds all string table initialization vectors that can be used in the parser unit 17 for each of schemaId's. A specific configuration of the string table initialization vector store 16 is realized by, for example, a ROM area in which all the strings (or all string initialization vectors) are stored and references to the strings corresponding to schemaId's.

The string table initialization vector selection unit 15 determines a used string table initialization vector based on the schemaId reported from the header analysis unit 12 and sends it to the parser unit 17.

The parser unit 17 initializes (or overwrites) a string table with the string table initialization vector transmitted from the string table initialization vector selection unit 15, and processes the stream received from the stream input unit 11 using the initialized string table and the grammars and grammar set table received from the grammar selection unit 13. That is, the stream is converted into an event sequence (e.g. a sequence of SAX events) corresponding to an XML document and the converted event sequence is output to an application (not illustrated). The application interprets content of the XML document according to the event sequence and performs operation based on a result of the interpretation.

A specific explanation with respect to the string table and the initialization vector will be given later.

In the following, a structure of an EXI stream, a structure of an EXI stream header, a structure of an EXI grammar, a string table initialization vector and parse processing (especially using xsi:type) will be explained.

The EXI stream is formed with the EXI stream header, the header option and a stream corresponding to a text body. The header option is an EXI document (i.e. EXI stream) itself based on a specific schema.

The stream has a structure in which a pair of an event code (EventCode) and a value (Value) is repeated. Document structuration by tags (or elements) in XML is expressed by recursive occurrence of the repetition of a pair of an event code and a value, which corresponds to a sub-element, in the above value part. A configuration example of the EXI stream body will be schematically illustrated in FIG. 2. By the even code of being defined by the EXI grammar, efficient encoding of EXI for the XML document structure is realized.

A structure of the EXI stream header is defined in Section 5 in Non-Patent Document 1. There is a case where the header structure has the EXI option in addition to a fixed-length header part that is necessarily included. Whether there is the EXI option is decided by Presence Bit of the header part. The EXI option itself is an EXI document described with a schema defined by the EXI specification.

Although various types of description are possible in the EXI option, an Important element in the present embodiment Is schemaId. This schemaId is a character string to report, information that by which schema the original XML document was encoded into the EXI stream, from the EXI decoder on the transmission side to the EXI decoder.

The XML document is converted into an event sequence and the event sequence is encoded into the EXI stream according to the EXI grammar(s) in the EXI encoder wherein the EXI grammars have been generated based on the EXI specification from the schema. A method of generating the EXI grammar from the schema is described in Non-Patent Document 1.

Here, elements included in the grammar will be explained. One grammar defines one state machine and is generated for each of types defined in a schema. To be more specific, individual grammars include the following structure.
label of type and state machine corresponding to the label
a set of states (and definition of the initialization state and terminal state) wherein the states are elements forming the state machine
state transition(s) from each state to own or different state wherein the transition(s) is elements forming the state machine

Also, the EXI grammar defines the following for each state transition.
event type (such as SD (StartDocument), SE (StartElement), AT (Attribute), CH (Character), EE (EndElement) and ED (EndDocument))
auxiliary-element with respect to an event (such as a label of a tag forming the XML element and an attribute key)
type of an event value (Terminal in the EXI specification), which indicates a different “type” or a built-in data type such as an integer and a string)
next transition state (NonTerminal in the EXI specification)

The grammar store 14 has a storage area to store type grammars defined in the above format. The type grammars corresponding to individual types are independently stored. Besides, the grammar store 14 has the grammar set table (see FIG. 5) in which the QName indicating a type and a type grammar are held for each schemaId.

The grammar selection unit 13 reads a corresponding part from the grammar set table based on the schemaId input from the header analysis unit 12 and outputs the corresponding part of the grammar set table and the grammar(s) corresponding to the schemaId to the parser unit 17. The grammar set table includes a reference to each of individual type grammars, and therefore the parser can find a corresponding type grammar according to a pair of a schemaId and QName.

Here, the string table and the initialization vector will be described in detail.

In EXI, the string table is used to avoid retransmission of known character strings.

The string table is a table used to reuse a prescribed character string and a character string present in a document, which are defined in Section 7.3 of Non-Patent Document 1. The string table is initialized into the same content in the encoder and the decoder, respectively, and, in case of transmission of a character string from the encoder to the decoder, the same change is made on the encoder side and the decoder side for the table. The string table is used to refer to, by numbers, a character string appeared in a schema and the same character string appeared in an XML document two times or more. To be more specific, numbers are assigned to character strings appeared in a stream in order and the character strings can reused by their numbers. The number is assigned to a value part corresponding to an event code. Incidentally, regarding a character string to which no number is assigned, the character string itself is included as a value part corresponding to the event code.

The URL (URI) of a name space included in an XML schema used for grammar generation is used to initialize the string table. For example, expression (QName) of a tag name included in a schema is designated by a number using the name space in this initialized string table. Therefore, even in the same grammatical structure, the initial value of the URL included in the string table varies depending on a used schema.

To solve this, a string table initialization vector corresponding to each of individual schemaId's is prepared and stored in a memory (the string table initialization vector store 16). Also, in response to the schemaId of an input EXI stream, a string table initialization vector is selected (the string table initialization vector selection unit 15). The selected string table initialization vector is output to the parser unit 17, and the parser unit 17 initializes the string table by the received string table initialization vector.

The string table will be explained in more detail. The string table is used with four items of (1) URI (URL), (2) prefix, (3) URI and local name in QName and (4) value. For efficient encoding, the string table is divided into the following partitions.
URI: including a character of“URI” and a URI part in QName
prefix: created every URI to which the prefix belongs (which is used only in a specific mode and therefore is not described herein)
local name: a table of local names is created for name space to which the local name belongs
value: dynamically described in both a name space to which an element or attribute of the value belongs and a partition storing a global value

In the following, initialization of the URI partition and the local name partition will be described in detail.

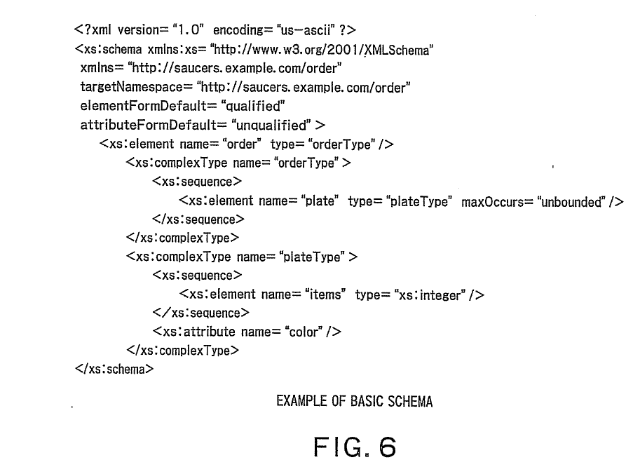

First, a basic schema for explanation will be illustrated In FIG. 6. The basic schema illustrated in FIG. 6 denotes an extract of an XML schema of a written order defined based on the following requirements by imaginary dish manufacturer SaucersCo. (saucers.example.com).
1. one written order can include an order of multiple (unbounded) types of dishes
2. a dish is designated by its color

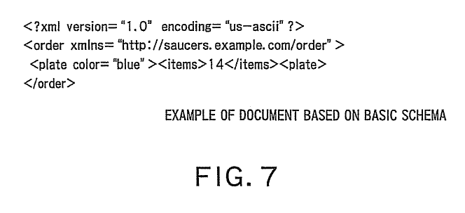

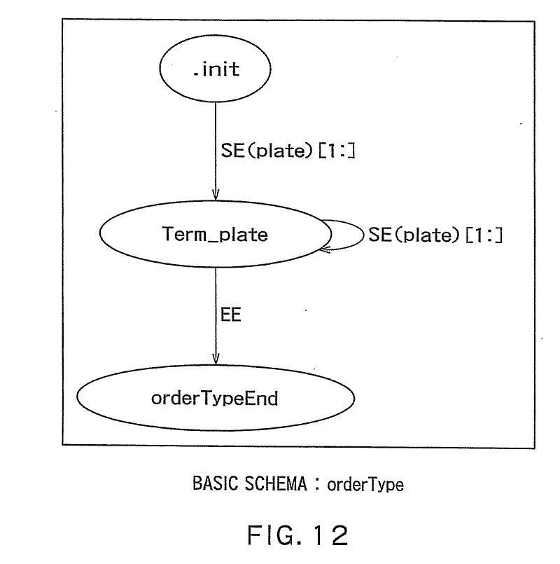

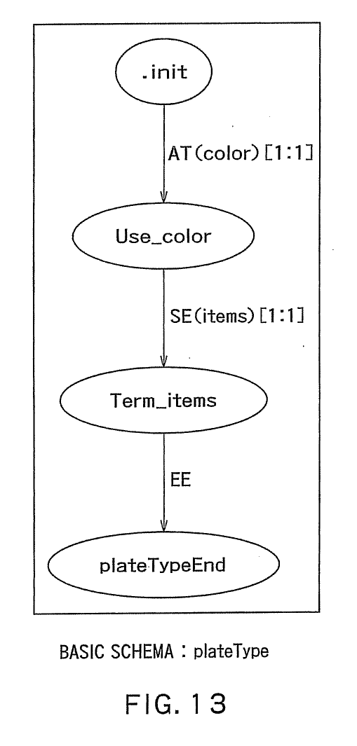

An example of the written order based on this schema will be illustrated in FIG. 7. In this document, 14 blue dishes are ordered. Also, a state transition diagram corresponding to each of two types defined by the basic schema in FIG. 6 will be illustrated in FIG. 12 and FIG. 13. FIG. 12 illustrates a state transition diagram of orderType and FIG. 13 illustrates a state transition diagram of plateType.

An initialization method of URI partitions is specifically described in Appendix D.1 in Non-Patent Document 1.

According to this, an initialization vector in the basic schema illustrated in FIG. 6 is as follows.

TABLE 1

| Partition | Compact ID | String Value |
|---|---|---|
| URI | 0 | “” (empty string) |
| URI | 1 | http://www.w3.org/XML/1998/namespace |
| URI | 2 | http://www.w3.org/2001/XMLSchema-instance |
| URI | 3 | http://www.w3.org/2011/XMLSchema |
| URI | 4 | http://saucers.example.com/order |

The URI's corresponding to Compact ID's 0 to 3 are constants defined by the specification, and the URI corresponding to the Compact ID 4 or subsequent URI's are name spaces derived from a schema.

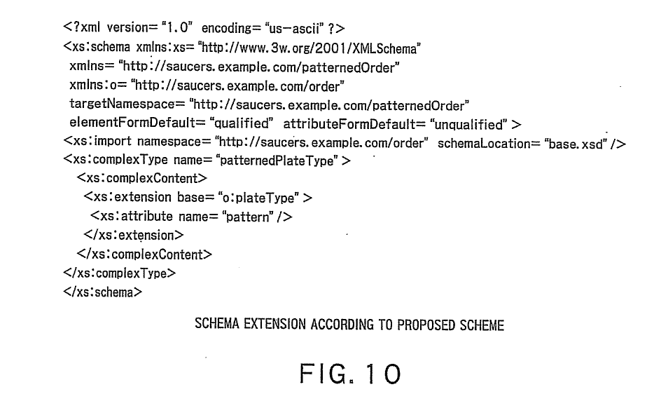

Also, in the extension schema (which imports the basic schema and will be described in detail later) according to the present proposed scheme illustrated in FIG. 10, there are two name spaces. Since these name spaces need to be added in dictionary order (i.e. alphabetical order), an initialization vector in this example is as follows.

TABLE 2

| Partition | Compact ID | String Value |
|---|---|---|
| URI | 0 | “” (empty string) |
| URI | 1 | http://www.w3.org/XML/1998/namespace |
| URI | 2 | http://www.w3.org/2001/XMLSchema-instance |
| URI | 3 | http://www.w3.org/2011/XMLSchema |
| URI | 4 | http://saucers.example.com/order |
| URI | 5 | http://saucers.example.com/patternedOrder |

Similarly, an initialization vector of a string table corresponding to a local name is created for name space. Regarding an initialization vector derived from the terms of XML, see Appendix D.3 in Non-Patent Document 1. Here, only an initialization vector derived from a schema will be specifically described.

The local names (i.e., an initialization vector) derived from the basic schema illustrated in FIG. 6 are as follows.

TABLE 3
Name Space: http://souacers.example.com/order

| Compact ID | String Value |
|---|---|
| 0 | color |
| 1 | items |
| 2 | order |
| 3 | orderType |
| 4 | plate |
| 5 | plateType |

Similarly, a local name derived from the extension schema illustrated in FIG. 10 is as follows.

TABLE 4
Name space: http://souacers.example.com/order

| Compact ID | String Value |
|---|---|
| 0 | color |
| 1 | items |
| 2 | order |
| 3 | orderType |
| 4 | plate |
| 5 | plateType |

TABLE 5
Name space: http://saucers.example.com/patternedOrder

| Compact ID | String Value |
|---|---|
| 0 | pattern |
| 1 | patternedPlateType |

5

As described above, the string table initialization vector selection unit 15 selects a string table initialization vector (in the above example, each table such as an URI partition and a local name partition) according to the schemaId reported from the header analysis unit 12 and reports it to the parser unit 17. The parser unit 17 initializes the string table by the reported initialization vector.

Parse processing in the parser unit 17 in EXI is performed in the following steps. That is, this corresponds to a pushdown automation. In the parser unit 17, a grammar setting table corresponding to schemaId is given from the grammar selection unit 13. Since the initial grammar is previously determined by the EXI specification, the decode starts from the initialization state corresponding to the grammar set table, in the following steps.
1. reading data from a stream by a bit width designated by the current grammar and processing this as an event code (which is an event code included in a pair of the above event code (EventCode) and value (Value))
2. reading transition corresponding to the event code from a transition table corresponding to the current state
3. recording an event type and reading a corresponding value (which is a value included in a pair of the above event code (Event Code) and value (Value)).

Regarding the “value” in this case, a reading method is defined by a “value type” recorded in the transition.

It should be noted that, in a case where an event type is SE or AT, the corresponding value may indicate a different type grammar itself. At this time, parse processing recursively shifts to the designated type grammar. When the shifted type grammar is terminated, it returns to the current grammar processing. Therefore, a value indicating the transition destination grammar may be referred to as “terminal.”
4. indicating the next state in a case where the current grammar continues (i.e. there is an event in which it should be read). Since the current grammar is not terminated, a value at this time may referred to as “nonterminal.”

Regarding more detailed explanation of the parse processing, see Non-Patent Document 1.

Although there are various kinds of definition of EXI specifications, especially, the xsi:type specification relates to the present embodiment and therefore will be explained.

As described above, the xsi:type is a specification defined by XML-Schema-Instance specification (which is defined by a name space of http://www.w3.org/2001/XMLSchema-instance, where “xsi” is the prefix of XMLSchema-instance), and explicitly specifies a type with which XML element is interpreted.

In XML, designation of the type is performed by designating a type name with use of xsi:type attribute. In EXI, similarly, if an AT(xsi:type) event occurs at interpreting of an element, the grammar is then switched. Steps of decode processing including the grammar switching are as follows.
1. reading data from a stream by a bit width designated by the current grammar and processing this as an event code
2. reading transition corresponding to the event code from a transition table corresponding to the current state
   If the event code is AT(xsi:type), the grammar table is looked up using QName (i.e. value corresponding to the event code) to specify a grammar corresponding to the QName, the currently used grammar is switched to the specified grammar and the reading starts from step 1.
   Otherwise, the processing continues.
3. recording an event type and reading a corresponding value. Regarding the “value” in this case, a reading method is defined by a “value type” recorded In the transition. It should be noted that, in a case where an event type is SE or AT, the corresponding value may indicate a different type grammar itself. At this time, parse processing recursively shifts to the designated type grammar. When the shifted type grammar is terminated, it returns to the current grammar processing. Therefore, a value indicating the transition destination grammar may be referred to as “terminal.”
4. indicating the next state in a case where the current grammar continues (i.e. there is an event in which it should be read). Since the current grammar is not terminated, a value at this time may referred to as “nonterminal.”

Here, the use of the xsi:any attribute and encoding of QName at the use of the xsi:any will be explained in detail.

Here, an example in a strict schema-informed grammar will be shown. Regarding other modes, see Non-Patent Document 1.

According to Section 8.5.4.4.2 of Non-Patent Document 1, in the case of holding a type of “named subtype” (i.e. derived type having a name) or “union”, AT(xsi:type) is added in the type grammar.

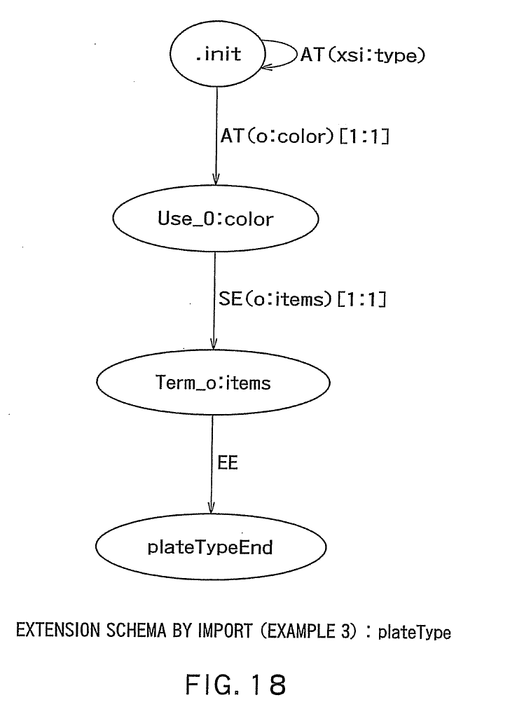

For example, in the extension schema according to the present proposed scheme illustrated in FIG. 10, plateType has a derived type of patternedPlateType, and therefore transition of AT(xsi:type) is added to this plateType. A state transition diagram of plateType in the basic schema of FIG. 6 will be illustrated in FIG. 13 and a state transition diagram of plateType in the extension schema (i.e. extension schema by import) according to the present proposed scheme in FIG. 10 will be illustrated in FIG. 18.

Here, in the extension schema by import, it is possible to change a type of the plate tag from plateType to patternedPlateType by the xsi:type attribute. Although the type designation at this time is performed with QName, the above string table is used for this designation. To be more specific, the type is designated by a pair of Compact ID(5) indicating a name space of http://saucers.example.com/patternedOrder and Compact ID(1) corresponding to a local name of patternedPlateType belonging to the corresponding name space.

The decoder of the present embodiment can specify a name space and local name by a pair of these Compact ID values, look up the grammar store 14, switch the current grammar to a grammar which has a corresponding type name (patternedPlateType in this case) and can be used on the current schemaId.

In the following, a specific example of the present embodiment will be shown based on the above basic schema (FIG. 6) and the written order based on the schema (FIG. 7).

As described above, FIG. 6 defines an XML schema of a written order defined based on the following requirements by imaginary dish manufacturer SaucersCo. (saucers.example.com).
1. one written order can include an order of multiple (unbounded) types of dishes
2. a dish is designated by its color

Here, it is assumed that, with business expansion, SaucersCo. begins handling patterned dishes. Since the above requirement definition does not include a dish pattern in the written order based on the basic schema, it is not possible to handle dishes of the same color and different patterns. Therefore, it is necessary to extend the schema in any way.

Simply thinking of it, it follows that a conventional schema may be extended.

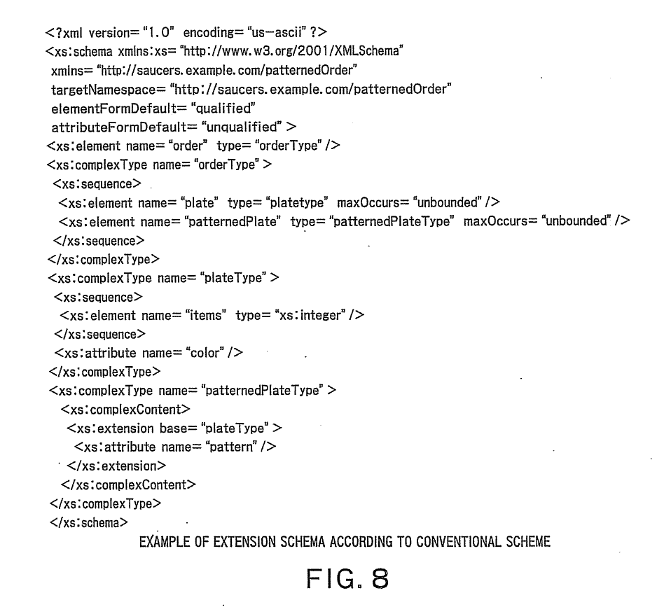

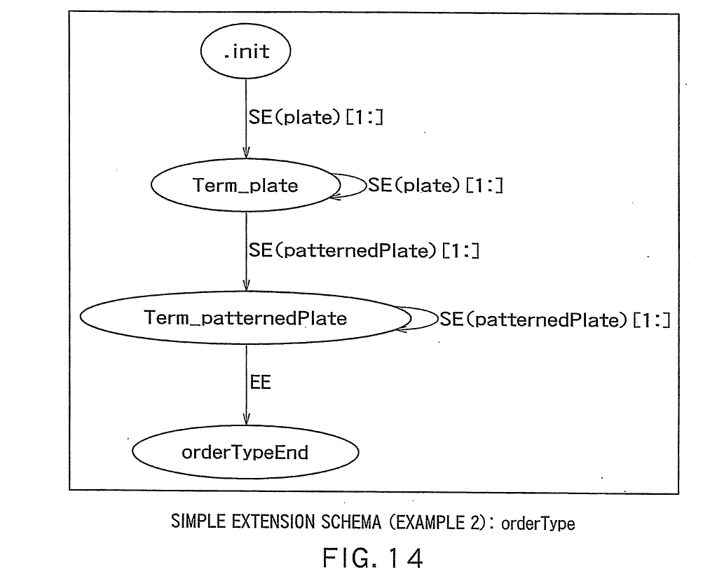

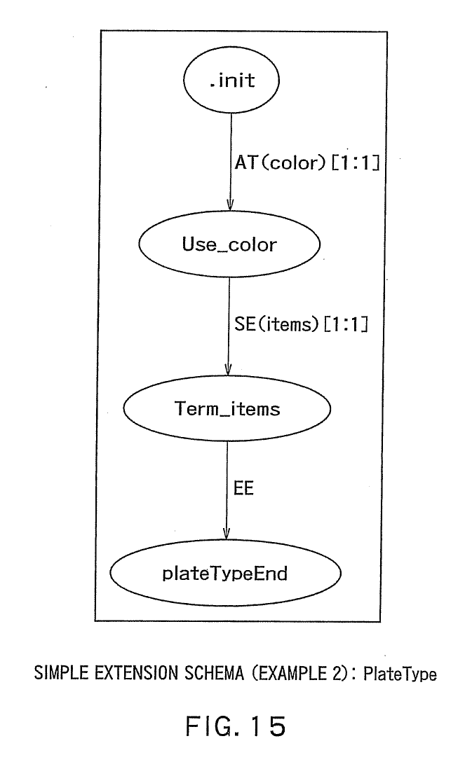

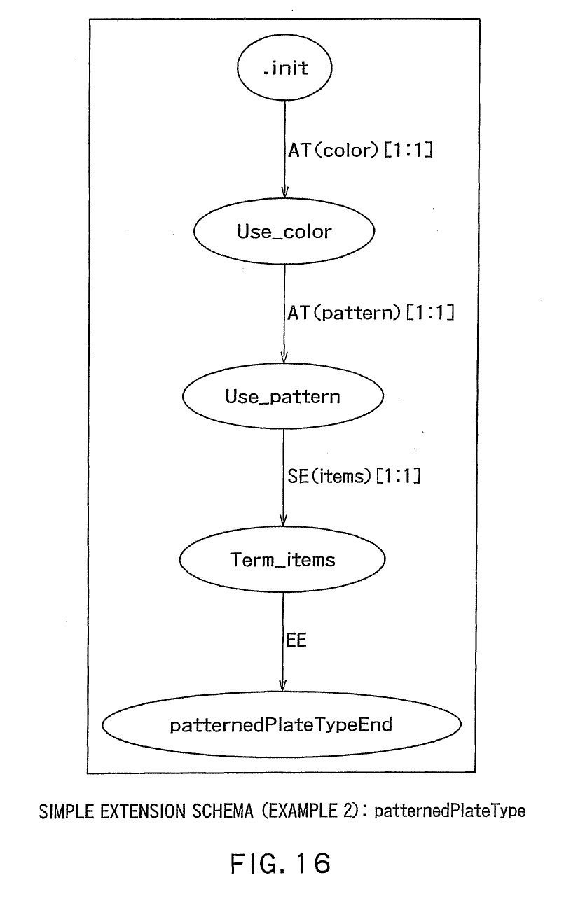

For example, FIG. 8 illustrates a schema (which will be referred to as “extension schema according to the conventional scheme” or simply referred to as “extension schema”) including patternedPlateType which is an extended type of plateType in the basic schema. The state transition diagram corresponding to each type defined by the extension schema according to the conventional scheme will be illustrated in FIG. 14, FIG. 15 and FIG. 16. FIG. 14 illustrates a state transition diagram corresponding to orderType. FIG. 15 illustrates a state transition diagram corresponding to plateType. FIG. 16 illustrates a state transition diagram corresponding to patternedPlateType.

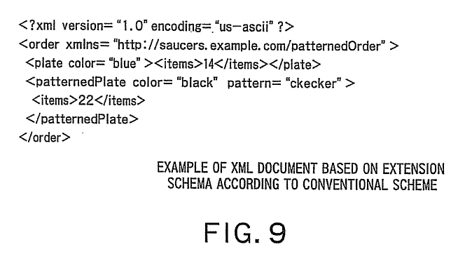

When ordering a patternless dish, an orderer may use a plate tag (plateType type) to describe an XML document. When ordering a patterned dish, the orderer may use a patternedPlate tag (patternedPlateType type) to describe an XML document. A description example of the XML document in the case of ordering a patterned dish will be illustrated in FIG. 9.

There is no problem in this scheme in the case of XML processing. However, when EXI is used for the operational efficiency of this order, it is found that there is an inefficient aspect. It is a change of the order tag (orderType type).

In EXI operating in the schema-informed grammar, a grammar is generated according to type information defined by the XML schema. The grammar is a state machine and shared between an encoder and a decoder. A different small number is assigned to each of state transitions in the state machine in accordance with a certain scheme. The assigned number is transmitted to the decoder side with a minimal number of bits used. Thereby, document information is shared on the encoder side and the decoder side.

Here, if the order tag changes, sharing of information is impossible between the encoder side and the decoder side. To be more specific, in view of the following two points, the decode fails: the number assigned to the state transition changes; and the minimal number of bits changes to express the number of pieces of the total transitions.

For example, when the total transition increases from 4 to 5, the bit number required to express the state changes from 2 bits to 3 bits. This bit number is determined based on a state machine. For this reason, in a case that the state machine is not shared between the encoder side and the decoder side, the bit numbers to be read are mismatched. Therefore, it is not possible to perform the subsequent decode.

Here, based on FIG. 12 and FIG. 14, change in the order tag in the extension schema according to the conventional scheme will be illustrated in detail. As described above, FIG. 12 illustrates a state transition diagram of ordertype (order tag) and FIG. 14 illustrates a state transition diagram of ordertype in the extension schema according to the conventional scheme. As seen from the comparison of both figures, it is found that, in the case of extension according to the conventional scheme, the state transition diagram of ordertype changes. Therefore, it is difficult to share the state machine. That is, the state number changes due to tag addition, and, as a result, a creation method of an EXI event code also changes. It should be noted that, in the figures, labels in two types of brackets represent an event name and a repetitive rule, respectively.

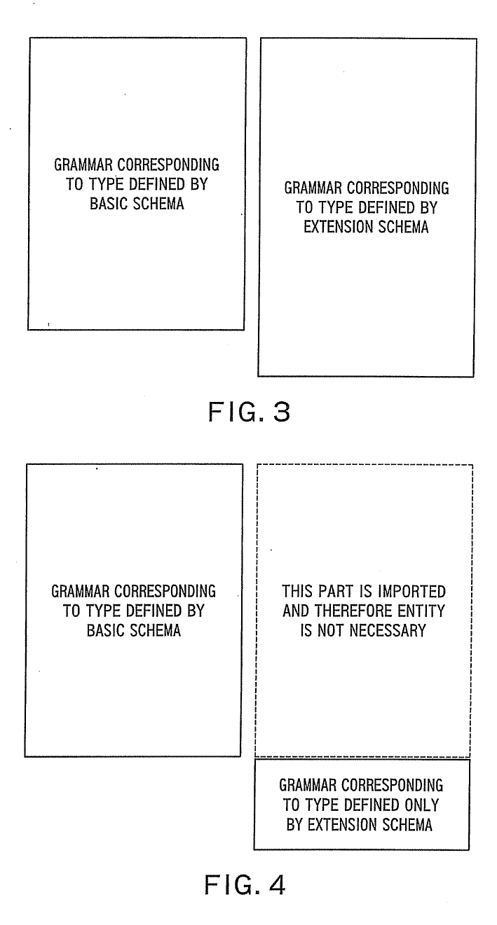

Therefore, in the conventional extension method shown in FIG. 8, it is necessary to hold EXI grammars (state machines) individually corresponding to both the basic schema in FIG. 6 and the extension schema according to the conventional scheme in FIG. 8. This will be illustrated in FIG. 3. FIG. 3 is an image diagram illustrating a memory storage scheme of EXI grammars in the related art. Thus, the amount of codes that have to be implemented, linearly increases as a number of schemas increases, which is inefficient.

By contrast with this, in the present proposed scheme, the extension schema is defined in a format that the basic schema is imported. In addition, in the extension schema, a type in the basic schema is made derived. Only in the case of adopting this scheme, a state machine corresponding to only a difference of the extension schema from the basic schema is added without changing the state machine corresponding to the basic schema so that it is possible to use both the basic schema and the extension schema.

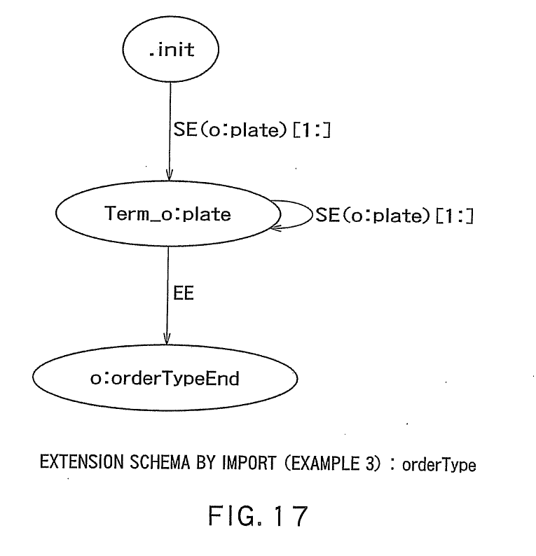

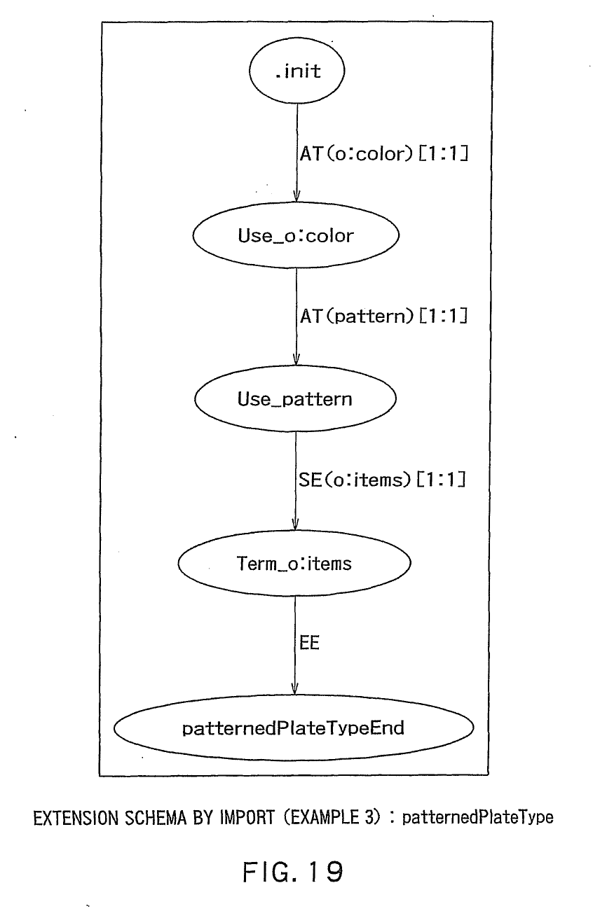

FIG. 10 illustrates an extension schema according to the present proposed scheme. The state transition diagram corresponding to each type defined in the extension schema according to the present proposed scheme will be illustrated in FIG. 17, FIG. 18 and FIG. 19. FIG. 17 illustrates a state transition diagram corresponding to orderType, FIG. 18 illustrates a state transition diagram corresponding to plateType and FIG. 19 illustrates a state transition diagram corresponding to patternedPlateType.

The extension schema in FIG. 10 is defined in a different XML name space from that of the basic schema. Besides, the basic schema is imported by means of an import sentence and plateType is extended to define patternedPlateType. It should be noted that a tag name corresponding to this patternedPlateType is not explicitly defined.

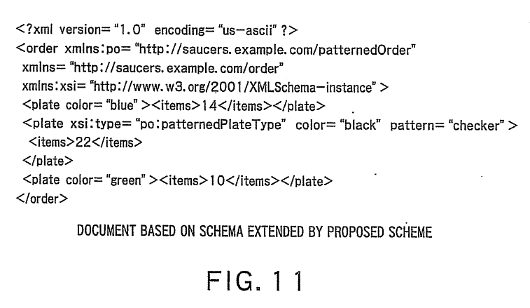

FIG. 11 illustrates an example of a written order by the extension schema according to the present proposed scheme in FIG. 10.

This XML document is seen as a complicated XML but is simple as a data model. As a name space corresponding to the extension schema, po is defined. The name space xsi is based on the XML specification.

The order tag is created based on the basic schema and includes three plate tags. In the second plate tag among these, po:patternedPlateType is explicitly type-designated with use of the xsi:type attribute. po:patternedPlateType is derived from plateType and therefore it is possible to replace the type here. By this means, it is possible to describe the pattern attribute. It should be noted that, in the case of the example in FIG. 11, although po:patternedPlateType is designated as a value corresponding to AT(xsi:type), a text of “po:patternedPlateType” itself is designated as a value (see above Table 4 and Table 5) since po:patternedPlateType is not present in the string table. In the case of switching a grammar according to the event code AT(xsi:type), po (i.e. http://saucers.exmaple.com/patternedOrder) is used as the name space (corresponding to ns0 or ns1, etc.) illustrated in FIG. 5 and patternedPlateType is used as a local name (corresponding to a, b or the like) so that a corresponding grammar is selected.

In the scheme according to the present embodiment, the basic schema is imported, without be changed at all, in the extension schema and xsi:type is utilized to use the extended type. Thereby, only the difference EXI grammar is mounted in the extension schema. By the present scheme, the grammar structure becomes compact, which is more efficient. That is, since the basic grammar is installed without change by the import, the common part is maximized and therefore only a difference grammar may be held. FIG. 4 illustrates an image view illustrating a memory storage scheme of the EXI grammar based on the proposed scheme.

The present embodiment is available for communication of a built-in device. For example, it is assumed that there is a home network protocol that performs communication by performing EXI-coding of a payload defined by the XML schema. In the home network often using a radio, a strict schema-informed grammar that can reduce the payload size is an advantageous scheme. It is necessary to support individual extension schemas for extension. In the related art, all grammars corresponding to all schemas are individually prepared and have to be stored in a memory each time an XML schema is extended. This is inadequate for use in a system with strict resource restriction.

On the other hand, according to the proposed scheme, it is possible to implement an extension schema by only incorporating a grammar corresponding to an extended difference. By this means, it is possible to easily mount various extensions on a built-in device such as lower-price and lower-spec home electronics, sensor and meter.

The EXI grammar size is substantially proportional to the number of state transitions. From this, in a case where there are two grammar sets in which one grammar set shares 95% grammars with the other grammar set and holds extended 5% grammars, it is sufficient to only hold 105% grammars (for example, basic schema 100% and extension schema 5%) in the proposed scheme although, in the related art, it is necessary to hold two grammar sets all.

In the above explanation, although the present embodiment and its advantages have been described with respect to a decoder, the present embodiment is similarly applicable to an encoder. By utilizing a state machine (type grammar) of the basic schema, only a state machine (type grammar) corresponding to an extended type has only to be incorporated to the extension schema. Thereby, it is possible to share the state machines between the basic schema and the extension schema. Therefore it is possible to save the storage area size of the encoder.

As described above, according to the present embodiment, in a case of defining a vendor extension schema, a type of an extended part is defined as the extension type by deriving a type defined in the basic schema, and the extension type is used by making type designation of the xsi:type attribute of the XML schema instance specification. By this means, it is possible to mount the extension schema without changing a state machine (type grammar) to express the basic schema. As a result, a common part between basic-schema-informed state machines and extension-schema-informed state machines is maximized, the program size and the memory usage are reduced and the number of built-in device types that can be mounted on an EXI processing system increases.

The EXI decoder of this embodiment may also be realized using a general-purpose computer device as basic hardware. That is, the stream input unit, the header analysis unit, the grammar selection unit, the string table initialization vector selection unit and the parser unit can be realized by causing a processor mounted in the above described computer device to execute a program. In this case, the EXI decoder may be realized by installing the above described program in the computer device beforehand or may be realized by storing the program in a storage medium such as a CD-ROM or distributing the above described program over a network and installing this program in the computer device as appropriate. Furthermore, the grammar store and the string table initialization vector store may also be realized using a memory device or hard disk incorporated in or externally added to the above described computer device or a storage medium such as CD-R, CD-RW, DVD-RAM, DVD-R as appropriate.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A description method of an extension schema and an XML (Extensible Markup Language) document corresponding to the extension schema, for encoding or decoding compatible with both a basic schema and the extension schema based on an EXI (Efficient XML Interchange), the basic schema defining at least one data type, comprising:
describing the extension schema such that the extension schema includes description to import the basic schema and description to define an extended data type which is a data type derived from one of the at least one data type; and
describing the XML document corresponding to the extension schema such that the XML document includes description to designate the extended data type with use of an attribute for type extension defined by an XML schema instance specification.

2. The method according to claim 1, wherein the attribution for type extension is an xsi:type attribute.

3. An EXI decoder which decodes an EXI (Efficient XML (Extensible Markup Language) Interchange)) stream, comprising:
a grammar store storing a first type grammar and a second type grammar,
the first type grammar being a type grammar generated according to an EXI specification from a basic schema of an XML wherein the basic schema defines at least one data type and the first type grammar is generated correspondingly to each of the at least one data type and
the second type grammar being a type grammar that, among type grammars generated according to the EXI specification from an extension schema of XML, a type grammar common to the first type grammar is excluded wherein the extension schema defines at least one data type, each of the type grammars is generated correspondingly to each of the at least one data type and the extension schema includes description to import the basic schema and description to define an extended data type which is a data type derived from one of the at least one data type;
a stream input unit to receive an EXI stream; and
a parser unit configured to decode the EXI stream, when the EXI stream is compatible with the basic schema, based on the first type grammar, and, when the EXI stream is compatible with the extension schema, based on the first type grammar and the second type grammar.

4. The EXI decoder according to claim 3, further comprising a header analysis unit configured to decide, based on a schema ID included in an EXI header option, the EXI stream is compatible with either of the basic schema or the extension schema,
wherein the parser unit determines, based on a decision by the analysis unit, a schema with which the EXI stream is compatible among the basic schema and the extension schema.

5. A non-transitory computer readable medium having stored therein instructions, which when executed by a processor, causes the processor to execute steps comprising:
accessing a grammar store storing a first type grammar and a second type grammar,
the first type grammar being a type grammar generated according to an EXI specification from a basic schema of an XML wherein the basic schema defines at least one data type and the first type grammar is generated correspondingly to each of the at least one data type and
the second type grammar being a type grammar that, among type grammars generated according to the EXI specification from an extension schema of XML, a type grammar common to the first type grammar is excluded wherein the extension schema defines at least one data type, each of the type grammars is generated correspondingly to each of the at least one data type and the extension schema includes description to import the basic schema and description to define an extended data type which is a data type derived from one of the at least one data type;
receiving an EXI stream; and
decoding the EXI stream, when the EXI stream is compatible with the basic schema, based on the first type grammar, and, when the EXI stream is compatible with the extension schema, based on the first type grammar and the second type grammar.

6. The medium according to claim 5, having stored therein instructions, which when executed by the processor, further causes the processor to execute steps comprising:
deciding, based on a schema ID included in an EXI header option, the EXI stream is compatible with either of the basic schema or the extension schema, and
determining, based on a result of a decision, a schema with which the EXI stream is compatible among the basic schema and the extension schema.
